(19) United States
(12) Patent Application Publication
(10) Pub. No.: US 2013/0006859 A1
(43) Pub. Date: Jan. 3, 2013

(54) PAYMENT SYSTEM AND METHOD USING HUMAN BODY COMMUNICATION

(75) Inventor: Jong Bok Lee, Yongin (KR)

(73) Assignee: HYUNDAI MOTOR COMPANY, Seoul (KR)

(21) Appl. No.: 13/241,728

(22) Filed: Sep. 23, 2011

(30) Foreign Application Priority Data
Jun. 29, 2011 (KR) 10-2011-0063862

(51) Int. Cl. G06Q 40/00

(52) U.S. Cl. 705/44; 705/39

(57) ABSTRACT

Disclosed is a payment system and method using HBC to communicate between a vehicle terminal and a payment terminal. More specifically, a vehicle terminal including a HBC unit links HBC using a human body as a medium, and a storage unit which stores user payment information and purchase information is provided. Additionally, a control unit, which provides the user payment information to the payment terminal, performs a payment if the HBC is successfully/validated by the HBC unit.

### CROSS-REFERENCES TO RELATED APPLICATIONS

The priority of Korean patent application No. 10-2011-0063862 filed on Jun. 29, 2011, the disclosure of which is hereby incorporated in its entirety by reference, is claimed.

### BACKGROUND OF THE INVENTION

1. Field of the Invention

The present invention relates to a payment system and method using human body communication, and more particularly, to a technology which performs an automatic payment by providing user payment information to a gas station payment terminal using human body communication.

2. Description of the Related Art

Techniques which transmit/receive data using the human body as a medium of transmitting an electric signal typically transmit/receive an electric signal using the human body as a medium through an apparatus. This technique has been applied to various fields including medical diagnostic equipment. The apparatus typically includes an electrode for being in direct contact with the human body and uses the human body as a medium.

Since the apparatus can transmit the electric signal by contacting the human body to a specific apparatus, it is possible to transmit/receive data between a user and a system without providing separate wired or wireless communication equipment. Such a human body communication (HBC) apparatus has been applied to various fields to improve a user's convenience in data transmission without use of additional wired or wireless communication equipment or communication line.

Recently, the most emphasis is given to a user's convenience in vehicle development. After gassing up, a driver typically must provide a credit card or card information to a stranger (an employee of a gas station). Thus, in doing so, so that since there is a significant chance that an illegal copy or illicit use of the card may be made. Therefore, the security for the card is not sufficient.

Further, although drivers can record in a book or other manual entry device, the amount, date, place, and other data associated with that particular gas up, many drivers find it troublesome to record this data each time they gas up at the pump and it is difficult to manage information related to the vehicles lubrication (i.e., oil changes/fill-ups).

### SUMMARY OF THE INVENTION

Various aspects of the present invention have been made in view of the above problems, and provide a payment system and method which can perform an automatic payment by providing user payment information to a gas station payment terminal through human body communication (HBC).

According to an aspect of the present invention, a payment system using HBC is provided. The payment system may include a vehicle terminal including a HBC unit which links communication using the human body as a medium, a storage unit which stores user payment information and lubrication information, and a control unit which provides the user payment information to a payment terminal to provide payment in response to the HBC being performed by the HBC unit.

According to another aspect of the present invention, a payment system using HBC is provided. The payment system may include a payment terminal including a HBC unit which provides communication links using a human body as a medium, a fingerprint recognition unit which recognizes a fingerprint from a user, a certification unit which performs user certification using fingerprint information received through the HBC and fingerprint information recognized by the fingerprint recognition unit, and a control unit which provides a payment via card information through the HBC if the user certification is validated by the certification unit.

According to still another aspect of the present invention, a payment method using HBC is provided. The payment method may include performing HBC by a vehicle terminal and a payment terminal, transmitting user payment information to the payment terminal through the HBC via the vehicle terminal, performing user certification by the payment terminal, and performing a payment using the user payment information if the user certification is validated.

The methods and apparatus of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a configuration block diagram illustrating an exemplary payment system using human body communication (HBC) according to an illustrative embodiment of the present invention.

FIG. 2 is a detailed configuration diagram illustrating a HBC unit of FIG. 1.

FIG. 3 is a sequence diagram illustration an exemplary payment method using HBC according to the illustrative embodiment of the present invention.

### DETAILED DESCRIPTION

Hereinafter, exemplary embodiments of the present invention will be described in more detail with reference to illustrative drawings.

Like reference numerals in the drawings denote like elements. When it is determined that detailed description of a configuration or a function in the related disclosure interrupts understandings of embodiments in description of the embodiments of the invention, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

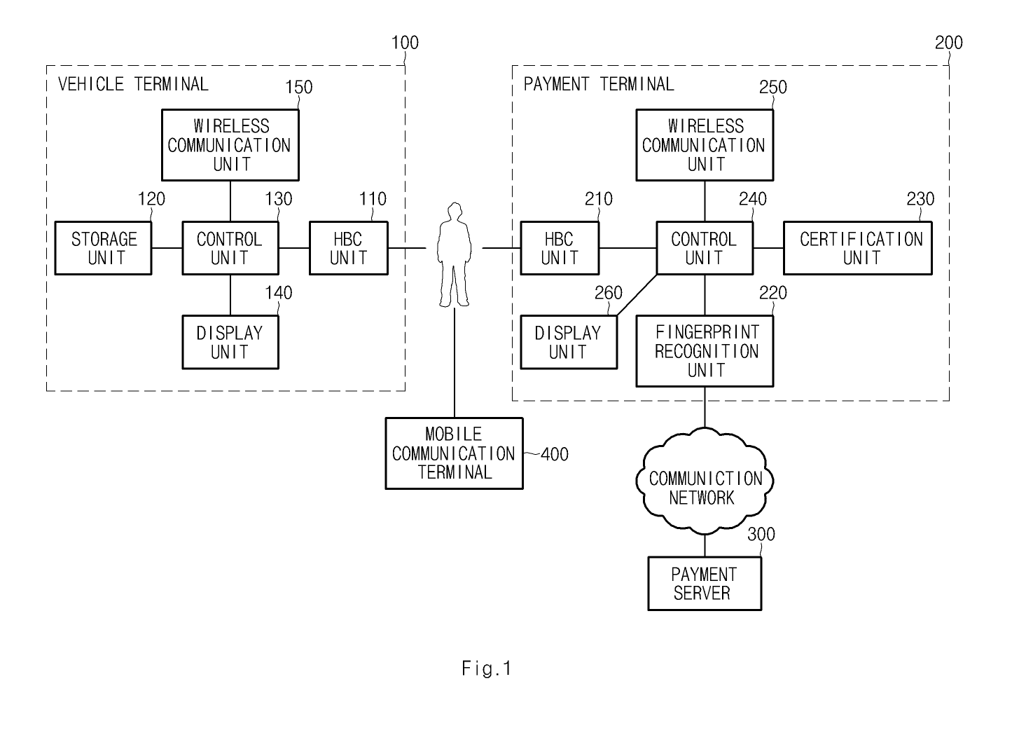

FIG. 1 is a configuration diagram illustrating a payment system using human body communication (HBC) according to an exemplary embodiment of the present invention.

A payment system using HBC according to an exemplary embodiment of the present invention performs a payment by performing and initiating an HBC with the vehicle terminal 100 included within a vehicle and a gas station side payment terminal 200 through a user's contact with the terminal 100.

The vehicle terminal 100 provides user payment information (e.g., a user's fingerprint information for certification, a phone number of a mobile communication terminal, card information for a payment, etc.) to the gas station payment terminal 200 through HBC if the vehicle terminal 100 links the HBC with the gas station payment terminal 200 using a human body as a medium.

Thus, the vehicle terminal 100 includes a HBC unit 110, a storage unit 120, a control unit 130, a display unit 140, and a wireless communication unit 150.

The HBC unit 110, if a hand of a user is touched, recognizes the user's touch and passes a micro current through a user's body to set a communication channel with a human body unit 210 of the payment terminal 200 using the human's body as a medium, thereby performing human body communication. The storage unit 120 stores user payment information (e.g., a user's fingerprint information for certification, a phone number of a mobile communication terminal, card information for a payment, etc.) and lubrication/gas information received from the payment terminal 200. At this time, each piece of information is encoded so that it is impossible to hack the information by the others.

The control unit 130 determines whether or not HBC using a human body as a medium has been successively linked between the HBC unit 110 of the vehicle terminal 100 and the gas station payment terminal 200. In response to a linking failure in the HBC, the control unit 130 is able to notify a mobile communication terminal that the HBC of the mobile communication terminal 400 has failed through the wireless communication unit 150. If it has not failed, a user's fingerprint information for a payment, a phone number of the mobile communication terminal 400, and card information for payment which are stored in the storage unit 120 are transmitted to the payment terminal 200 through the HBC unit 110 if the HBC linkage is validated.

The control unit 130 may apply and register lubrication/gas information to an electronic records book and display the lubrication information on a display unit 140, thereby allowing a user to account for and monitor the lubrication information in response to the lubrication information being received from the payment terminal 200 through the human body communication. Here, the control unit 130 may be implemented by an electronic control unit (ECC) included within a vehicle.

The display unit 140 displays information, such as a screen to which the HBC is linked, the lubrication/gas information, the data associated with the records book, or the like, on a screen if the HBC linkage is validated. At this time, it is preferable that the records book be accessible through the mobile communication terminal 400 of the user or an Internet site at anytime and anywhere.

The wireless communication unit 150 may be configured to perform wireless communication through wireless fidelity (Wi-Fi), wireless broadband (WiBro), a third generation (3G) communication network, or the like.

Although an example in which the HBC unit 110 is included in the vehicle 100 has been illustrated in FIG. 1, the HBC unit 110 may be embodied by a separate terminal from the vehicle terminal 100.

On the other hand, a gas station payment terminal 200 performs user certification using a user's fingerprint information received from the vehicle terminal 100 if the HBC is linked with the vehicle terminal 100, performs a payment using card information received from the vehicle terminal 100 if the user certification is validated, and provides lubrication/gas information in response to performing the payment to the vehicle terminal 100.

Thus, the payment terminal 200 includes a HBC unit 210, a fingerprint recognition unit 220, a certification unit 230, a control unit 240, a wireless communication unit 250, and a display unit 260. The HBC unit 210 performs HBC with the HBC unit 110 of the vehicle terminal 100 using a human body as a medium. The fingerprint recognition unit 220, in response to being touched by a user's hand, captures and recognizes a fingerprint of the user and transmits recognized fingerprint data to the certification unit 230.

The certification 230 performs user certification by comparing fingerprint information received from the vehicle terminal 100 with the fingerprint data recognized through the fingerprint recognition unit 220. That is, the certification unit 230 validates the user certification if the fingerprint information received from the vehicle terminal 100 is identical with the fingerprint data read on the fingerprint recognition unit 220 and that the user certification is not validated if the fingerprint information received from the vehicle terminal 100 is not identical with the fingerprint data read on the fingerprint recognition unit 220.

The control unit 240 performs a payment using card information received from the vehicle terminal 100 in conjunction with a payment server 300 if the user certification is validated through the certification unit 230 and controls a payment result to be transmitted to the mobile communication terminal 400 of the user via the wireless communication unit 250 and lubrication/gas information to be transmitted to vehicle terminal 100 through HBC if the payment is completed. If the user certification is not validated through the certification unit 230, the control unit 240 transmits a certification fail result to the mobile communication terminal 400 of the user through the wireless communication unit 250.

The wireless communication unit 250 may perform wireless communication through WiFi, WiBro, a 3G communication network, or the like. Additionally, the display unit 260 displays a payment amount on a screen.

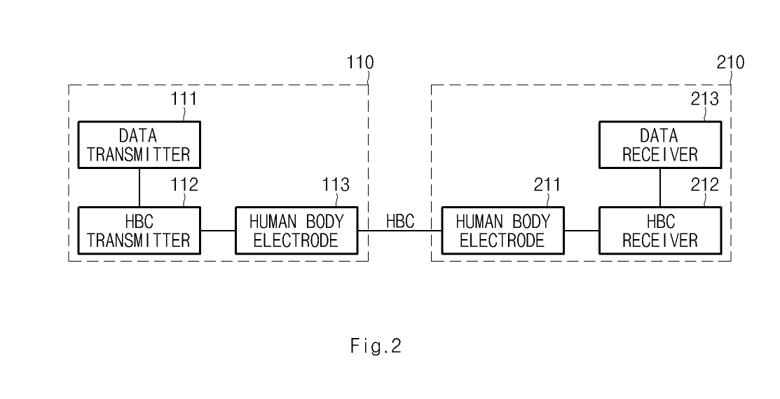

Hereinafter, a HBC process between the HBC unit 110 of the vehicle terminal 100 and the HBC unit 210 of the payment terminal 200 will be described in detail with reference to FIG. 2. More specifically, the HBC unit 110 of the vehicle terminal 100 includes a data transmitter 111, a HBC transmitter 112, and a human body electrode 113. The data transmitter 111 transmits certification information transmitted from the control unit 130 to the HBC transmitter 112. The HBC transmitter 112 converts the certification information transmitted from the data transmitter 111 into an electric signal which can be transferred using a human body as a medium and transmits the electric signal to the payment terminal 200 through the human body in contact with the human body electrode 113. At this time, the human body should be in contacted with the human body electrode 113 of the vehicle terminal 100 and a human body electrode 211 of the payment terminal 200. The human body electrode 113 transfers the electronic signal from the HBC transmitter 112 using the human body as a medium when the human body electrode 113 is in direct with the skin of the human body or is in contact with human body with a cloth being interposed therebetween.

The HBC unit 210 of the payment terminal 200 includes the human body electrode 211, a HBC receiver 212, and a data transmitter 213. The human body electrode 211 receives the electronic signal from the HBC transmitter 112 of the HBC unit 110 using the human body as a medium in the state that the human body electrode 211 is in direct contact with the skin of the human body or is in contact with the human body through a cloth being interposed therebetween. For example, the human body electrode 211 may be installed in a door knob of a vehicle.

The HBC receiver 212 converts the electronic signal received from the HBC unit 110 using the human body as a medium through the human body electrode 211 into original certification information and transmits the original certification information to the data receiver 213. The data receiver 213 receives certification information from the HBC receiver 212.

Accordingly, the HBC unit 110 of the vehicle terminal 100 and the HBC unit 210 of the payment terminal 200 may be implemented to enable bidirectional communication therebetween. That is, the HBC unit 110 of the vehicle terminal 100 may further include a HBC receiver and a data receiver and the HBC unit 210 of the payment terminal 200 may further include a HBC transmitter and a data transmitter, thereby being implemented to enable bidirectional communication therebetween.

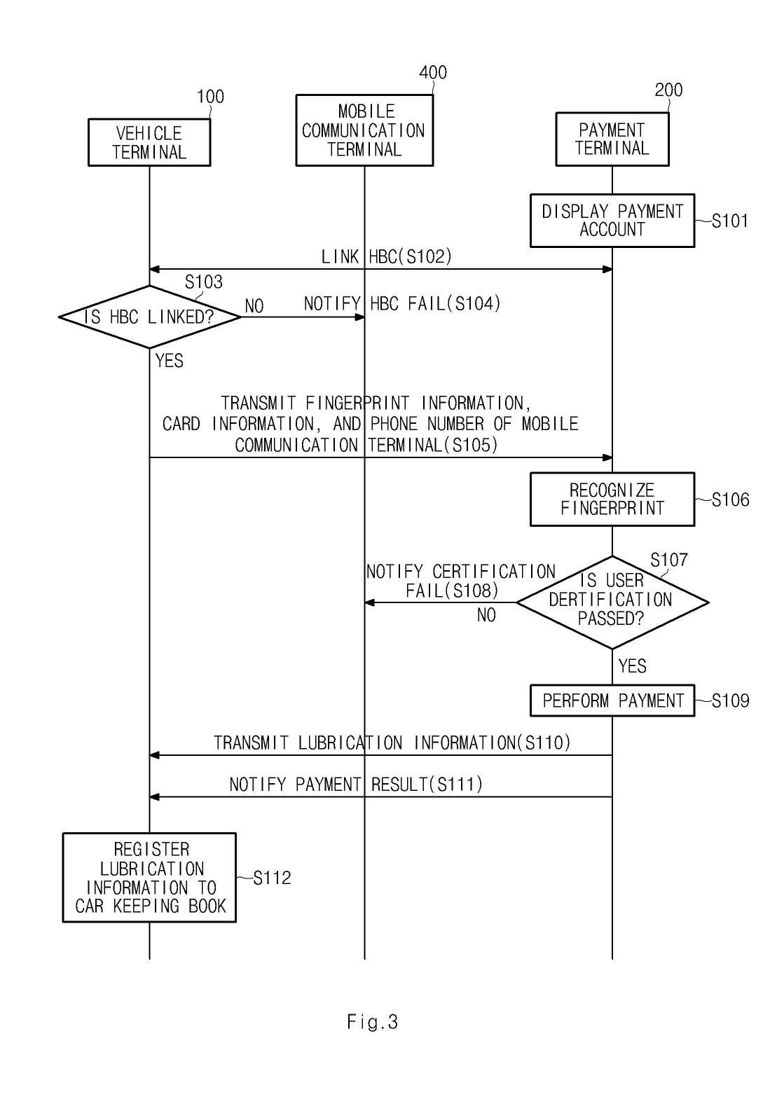

Hereinafter, a payment method using a human body according to an exemplary embodiment will be described with reference to FIG. 3. First, if a user gases up at a gas station, the payment terminal 200 displays a payment amount on a screen (S101) so that the user can check the payment amount. Afterwards, a hand of the user simultaneously touches the HBC unit 110 of the vehicle terminal 100 and the HBC unit 210 of the gas station side payment terminal 200 to perform a payment so that communication between the vehicle terminal 100 and the payment terminal 200 is linked via the human body as a medium (S102). The control unit 130 of the vehicle terminal 100 checks whether or not the HBC is linked (S103) and notifies the mobile communication terminal 400 of the user if the HBC is not linked (S104).

On the other hand, if the HBC is linked, the vehicle terminal 100 transmits user payment information (e.g., fingerprint information, card information, and a phone number of the mobile communication terminal) to the payment terminal 200 through the HBC (S105). Thus, the payment terminal 200 inputs and recognizes the user's fingerprint (S106) and performs user certification by comparing the recognized fingerprint data with fingerprint information received from the vehicle terminal 100 (S107).

If the user certification is not validated, the payment terminal 200 notifies the mobile communication terminal 400 of the user using the phone number of the mobile communication terminal received from the vehicle terminal 100 (S108) and induces the user to provide the user's fingerprint again thereby re-performing user certification using newly recognized fingerprint data.

On the other hand, if the user certification is validated, the payment terminal 200 performs a payment using card information received from the vehicle terminal 100 in conjunction with the payment server 300 (S109). If the payment is completed, the payment terminal 200 transmits lubrication/gas information to the vehicle terminal 100 through the HBC (S110) and transmits a payment result to the mobile communication terminal 400 of the user through a wireless communication network (S111). Thus, the vehicle terminal 100 registers the lubrication/gas information received from the payment terminal 200 to a record book and the lubrication information is updated and managed accordingly either by the control unit or the user, or both (S112).

The present invention has illustrated a payment process which may be completed at a gas station as an example, but the present invention may be applied to various fields applying a payment system, such as a department store, a restaurant, a grocery store, or a high-pass charge system.

The present invention processes a payment by simultaneously using a fingerprint of a user touching the HBC unit 110 of the vehicle terminal 100 and the HBC unit 210 of the payment terminal 200 without requiring the user to use cash or a credit card. Further, in the present invention, if the payment is completed ate a gas station, the payment terminal 200 transmits the lubrication/gas information to the vehicle terminal 100 through the HBC so that the record book is automatically updated and can be easily managed.

As seen from the above-described processes, user payment information is provided to the gas station payment terminal through HBC by merely touching the HBC unit so that the payment is automatically performed, thereby increasing the user's convenience. The prevent invention performs a payment without providing card information to a stranger (i.e., an employee of the gas station) so that the illegal copy of a card, and the like can be prevented.

In the present invention, the lubrication/gas information is automatically updated without recording the lubrication information each time manually when gassing up by a user so that user can check his or her lubrication/gas information via a mobile communication terminal or Internet anytime, thereby increasing the user's convenience.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A payment system using human body communication (HBC) comprising:
a vehicle terminal which includes:
a HBC unit which provides a communication link using a human body as a medium;
a storage unit which stores user payment information and purchase information; and
a control unit which controls to provide the user payment information to a payment terminal which performs a payment if the HBC is performed by the HBC unit.

2. The payment system according to claim 1, wherein the control unit, if the purchase information is received from the payment terminal, updates and manages the lubrication information to an electronic record book, wherein the purchase information is gas information.

3. The payment system according to claim 1, wherein the control unit, in response to a linking failure of the HBC, notifies a mobile communication terminal of a user of the linking failure.

4. The payment system according to claim 2, wherein the control unit, in response to a linking failure of the HBC, notifies a mobile communication terminal of a user of the linking failure.

5. The payment system according to claim 1, wherein the payment terminal is configured to perform user certification and provide a payment using the user payment information received from the vehicle terminal, if the HBC is linked with the vehicle terminal.

6. The payment system according to claim 5, wherein the payment terminal includes:
an HBC unit which provides a communication link using the human body as a medium;
a fingerprint recognition unit which recognizes a fingerprint from the user;
a certification unit which performs the user certification using fingerprint information received through the HBC and fingerprint information recognized through the fingerprint recognition unit; and
a control unit which performs the payment using card information received through the HBC if the user certification is passed by the certification unit.

7. The payment system according to claim 6, wherein the control unit, in response to completion of the payment, transmits the purchase information to the vehicle terminal through the HBC.

8. The payment system according to claim 1, wherein the user payment information includes at least one selected from a group consisting of card information, a phone number of a mobile communication terminal, and fingerprint information.

9. The payment system according to claim 2, wherein the user payment information includes at least one selected from a group consisting of card information, a phone number of a mobile communication terminal, and fingerprint information.

10. A payment system using human body communication (HBC) comprising:
a payment terminal which includes:
a HBC unit which provides a communication link between the payment terminal and a vehicle terminal using the human body as a medium;
a fingerprint recognition unit which recognizes a fingerprint from a user;
a certification unit which perform user certification using fingerprint information received through the HBC and fingerprint information recognized by the fingerprint recognition unit; and
a control unit which performs a payment using card information supplied through the HBC if the user certification is validated by the certification unit.

11. The payment system according to claim 10, wherein the control unit, in response to completion of a payment, transmits purchase information to a vehicle terminal through the HBC.

12. A payment method using human body communication (HBC) comprising:
performing HBC between a vehicle terminal and a payment terminal;
transmitting user payment information to the payment terminal through the HBC via the vehicle terminal;
performing user certification by the payment terminal; and
performing a payment using the user payment information in response to the user certification being validated.

13. The payment method according to claim 12, wherein the performing the user certification includes:
recognizing a fingerprint received from a user by the payment terminal; and
performing the user certification by comparing fingerprint information among the user payment information with recognized fingerprint information on the payment terminal.

14. The payment method according to claim 12, further comprising:
transmitting purchase information to the vehicle terminal through the HBC; and
updating and managing the purchase information to an electronic record book by the vehicle terminal.

15. The payment method according to claim 13, further comprising:
transmitting purchase information to the vehicle terminal through the HBC, wherein the purchase information is gas information; and
updating and managing the gas information to an electronic record book by the vehicle terminal.
